(19) United States
(12) Patent Application Publication
(10) Pub. No.: US 2016/0222602 A1
(43) Pub. Date: Aug. 4, 2016

(54) SYSTEMS AND METHODS FOR GUIDING A COMPACTING MACHINE

(71) Applicant: Caterpillar Paving Products Inc., Minneapolis, MN (US)

(72) Inventor: Bryan Joseph DOWNING, Champlin, MN (US)

(73) Assignee: Caterpillar Paving Products Inc., Minneapolis, MN (US)

(21) Appl. No.: 14/610,844

(22) Filed: Jan. 30, 2015

(51) Int. Cl. E01C 19/00; G01C 21/36

(52) U.S. Cl. CPC E01C 19/004; G01C 21/36

(57) ABSTRACT

A guidance system for a compacting machine has a data interface configured to receive real-time information indicative of a paving parameter and to receive project-specific information indicative of a construction parameter. The system further has a locating device configured to determine a location of the compacting machine and processing device in communication with the data interface and the locating device. The processing device is configured to use the real-time information and the project-specific information to determine a rolling pattern for the compacting machine and, based on the location of the compacting machine and the rolling pattern, provide directional guidance to the compacting machine.

### TECHNICAL FIELD

The present disclosure generally relates to a compacting machine, and more particularly, to systems and methods for guiding a compacting machine.

### BACKGROUND

The construction of road and highways typically involves a paving machine used to lay an asphalt mixture and a compacting machine (e.g., a roller machine) used to compact the mixture. The compactability of the asphalt mixture can be affected by environmental factors (e.g., ground temperature), mixture factors (e.g., composition properties), and construction factors (e.g., paving depth). A temperature of the asphalt mixture can also have an effect on its compactability. When the temperature of the asphalt mixture decreases, the mixture becomes more viscous and resistant to deformation, thus requiring higher compaction efforts. The composition of the asphalt mixture, which varies in dependence on expected loads caused by traffic and weather, also has an effect on its compactability. For example, mixtures that contain a high proportion of stones require high compaction efforts.

Traditional approaches rely upon operator judgment and perception, which require substantial operator training and preparation time. These approaches have the potential for human error and tend to be inconsistent in quality. Accordingly, when constructing long roads and highways, a significant number of pavement and rolling deficiencies appear. These deficiencies tend to increase construction time and cost. In recent years, several systems and methods have been developed for assisting operators of paving and compacting machines.

One method of improving the quality of paving operations is described in U.S. Pat. No. 6,749,364 (the '364 patent) issued to Baker et al. on Jun. 15, 2014. The '364 patent describes a pavement temperature monitoring system that can scan a material mat to be compacted. The '364 patent also discloses a display device connected with a temperature sensor that can be viewed by the operator of the compacting vehicle. The display device provides the operator of the compacting vehicle with a temperature profile of the material mat. According to the '364 patent, the pavement temperature monitoring system includes a “three light” indicator having a first light to indicate that the formed material mat is at the desired temperature, a second light to indicate that the formed material mat is at a higher temperature than the desired temperature, and a third light to indicate that the formed material mat is at a lower temperature than the desired temperature. This information may help the operator to adjust operational parameters of the compacting vehicle.

While the system of the '364 patent may improve the traditional approaches of paving, the '364 patent does not consider other factors that have an effect on the compactability of the asphalt mixture. In addition, the “three light” indicator disclosed in the '364 patent can be a cumbersome way to provide guidance to the operator. Accordingly, the '364 patent may provide an incomplete picture to the operator.

The disclosed systems and methods are directed to overcoming one or more of the problems set forth above and/or other problems of the prior art.

### SUMMARY OF THE INVENTION

In one aspect, the present disclosure is directed to a guidance system for a compacting machine. The guidance system may include a data interface configured to receive real-time information indicative of at least one paving parameter, and to receive project-specific information indicative of at least one construction parameter. The guidance system may further include a locating device configured to determine a location of the compacting machine and at least one processing device in communication with the data interface and the locating device. The at least one processing device may be configured to use the real-time information and the project-specific information to determine a rolling pattern for the compacting machine. Based on the location of the compacting machine and the rolling pattern, the at least one processing device may be further configured to provide directional guidance to the compacting machine.

In another aspect, the present disclosure is directed to another guidance system for a compacting machine. This guidance system may include a data interface configured to receive real-time information indicative of at least one paving parameter. The guidance system may further include at least one image capture device configured to acquire real-time image data from an environment of the compacting machine, a display device located inside the compacting machine, and at least one processing device. The at least one processing device may be configured to use the real-time information to determine a rolling pattern for the compacting machine, and to present a visual representation of the rolling pattern integrated with the image data on the display device.

In yet another aspect, the present disclosure is directed to a software product stored on a non-transitory computer readable medium and including data and computer implementable instructions, which when executed by at least one processing device of a compacting machine cause the compacting machine to perform operations. The operations may include receiving real-time information indicative of at least one paving parameter. The operations may also include acquiring real-time image data from an environment of the compacting machine. The operations may further include using the real-time information to determine a rolling pattern for the compacting machine. The operations may additionally include displaying a visual representation of the rolling pattern integrated with the image data.

### BRIEF DESCRIPTION OF THE DRAWINGS

FIG. 1 is a diagrammatic illustration of a paving system according to one exemplary embodiment;

FIG. 2 is a side diagrammatic illustration of a compacting machine according to one exemplary embodiment;

FIG. 3 is a flow chart illustrating an exemplary disclosed method for guiding the compacting machine of FIG. 2; and

FIG. 4 is an isometric illustration of a display device of the compacting machine of FIG. 2, showing a graphical user interface.

### DETAILED DESCRIPTION

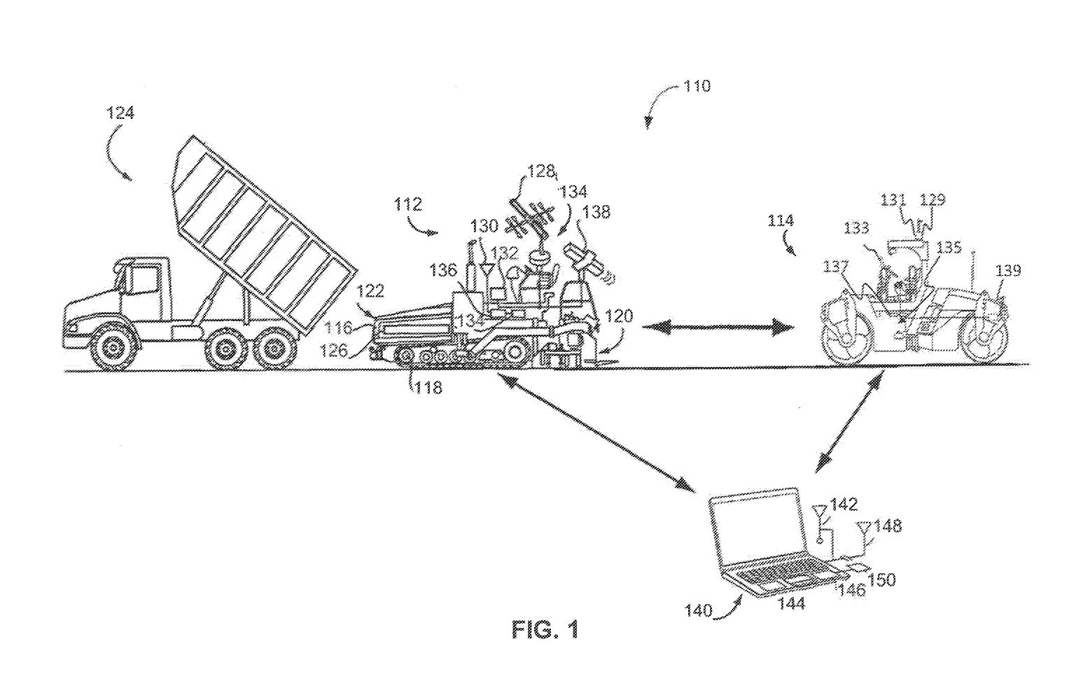

FIG. 1 is a diagrammatic illustration of a paving system 110 that includes at least one paving machine 112 and at least one compacting machine 114. Paving machine 112 includes a frame 116 having a set of ground engaging wheels or tracks 118 mounted thereto, as well as a screed 120 for working paving material (e.g., an asphalt mixture) in a conventional manner. Paving machine 112 may further include a hopper 122 for storing paving material supplied via a supply machine 124 or another supply machine. The paving material may be transferred from hopper 122 to screed 120 via a conveyor system 126. In some embodiments, paving machine 112 may include a receiver 128 configured to receive various electronic signals including position data, navigation commands, and paving-related information. The position data received via receiver 128 may include geographic position data such as GPS signals or local positioning signals, or position data indicative of the position of paving machine 112 relative to other machines of paving system 110. The navigation commands received via receiver 128 may include alert commands, start commands, stop commands, machine speed commands, conveyor speed commands, travel direction commands, etc. The paving-related information received via receiver 128 may include information from other machines of paving system 110 including, for example, paving material temperature data as measured by compacting machine 114. Paving machine 112 may also include a signaling device such as a transmitter 130 for outputting data signals or control signals to other machines. In addition, paving machine 112 may include a display device 132, such as an LCD display device. In one embodiment, display device 132 may present a map of a work area, including icons representing one or more of the machines of paving system 110.

In some embodiments, paving machine 112 may include a control system 134 for guiding and controlling paving machine 112. Control system 134 may include a processing device 136 coupled with each of receiver 128, transmitter 130, display device 132, and sensor 138. The term “processing device” may include any physical device having an electric circuit that performs a logic operation on input or inputs. For example, the processing device may include one or more integrated circuits, microchips, microcontrollers, microprocessors, all or part of a central processing unit (CPU), graphics processing unit (GPU), digital signal processor (DSP), field programmable gate array (FPGA), or other circuits suitable for executing instructions or performing logic operations. In some embodiments, the at least one processing device may be associated with a software product stored on a non-transitory computer readable medium and comprising data and computer implementable instructions, which when executed by at least one processing device, cause paving machine 112 to perform operations. The non-transitory computer readable medium may include a memory, such as RAM, ROM, flash memory, a hard drive, etc. The computer readable memory may also be configured to store electronic data associated with operation of paving system 110, for example, temperature data for paving material with which machines 112 and 114 interact, position data, time data, lift number data, and more.

In one embodiment, processing device 136 may receive real time information from sensor 138 during the paving operation. The real-time information may be transmitted to compacting machine 114, such that a rolling pattern may be determined in real-time. Sensor 138 may be any type of sensor or sensor group configured to sense some parameter value that is indicative of, either directly or indirectly, the performance of paving machine 112. Consistent with the present disclosure, sensor 138 may include, for example, a drum speed sensor, a temperature sensor, a speedometer, and more. In addition, sensor 138 may include one or more sensors unassociated with the performances of paving machine 112. For example, sensor 138 may be an optical temperature sensor such as an infrared camera configured to measure the temperature of the paving material. Alternatively, sensor 138 may be a non-optical sensor such as a digital or analog sensor configured to provide data regarding the performance of paving machine 112.

Compacting machine 114 may follow behind paving machine 112 and compact paving material distributed by paving machine 112 while the paving material is still relatively hot. Compacting machine 114 may include processing device 137 coupled with a receiver 129, a transmitter 131, a display device 133, and sensor 139. Receiver 129 may receive various electronic signals including position data, navigation commands, real-time information, and project-specific information. A detailed description of the information that receiver 129 may receive is provided below. Transmitter 131 may transmit position data indicative of a relative or geographic position of compacting machine 114, as well as electronic data such as data acquired via one or more sensors 139. Sensor 139 may measure various parameters, for example, the temperature of the paving material that compacting machine 114 is interacting with. In some embodiments, compacting machine 114 may include a control system 135 for guiding and controlling compacting machine 114. For example, control system 135 may determine a recommended rolling pattern and display the rolling pattern to the operator of compacting machine 114. In another embodiment, control system 135 may communicate directly with control system 134 in order to share processed electronic data generated during operation of paving system 110.

Consistent with exemplary embodiments of this disclosure, the control, monitoring, and/or data recording of paving system 110 may take place from a variety of locations, either onboard of machines 112, 114, or at a separate command center. It is contemplated that, for at least certain paving jobs, paving system 110 may be used with one or more control stations separate from each of the respective machines. A control station 140 may be a part of paving system 110. For example, control station 140 may include a computer monitored by a paving foreman, technician, etc., and may receive signals from any or all of the machines of paving system 110 and output control commands. Control station 140 may serve as an alternative or supplemental command center where personnel can monitor paving progress, view maps of the work area, etc. To this end, control station 140 may also include a receiver 142, an electronic control unit 144, a memory 146 and a transmitter 148. Electronic control unit 144 might also comprise a memory writing device 150 configured to record electronic data from any of machines 112, 114, or 124 on memory 146.

Control station 140 may also be configured to communicate with supply machines and/or even an asphalt plant to speed up or slow down paving material production, delivery, etc., based on progress of paving system 110. It should be appreciated that any or all of the control and data recording aspects of paving system 110 might take place at control station 140, via a laptop computer, a PDA, cell phone, etc. Typically, control station 140 will be in two-way communication with at least some of the machines of paving system 110, and also in one-way or two-way communication with machines and personnel associated with a supply chain for paving material. Additional stations (not shown), such as a quality control station and a validation station, may also be used. In some instances, a quality control station may be used to record data relating to comparisons between pre-established paving specifications and actual paving parameters. The quality control station could also be used to make any necessary changes in system operation between paving process stages. The quality control changes might take place via computer or by a technician. A validation station may also be set up at a work site to record information relating to paving specifications and paving quality, etc., for access by personnel other than paving contractors.

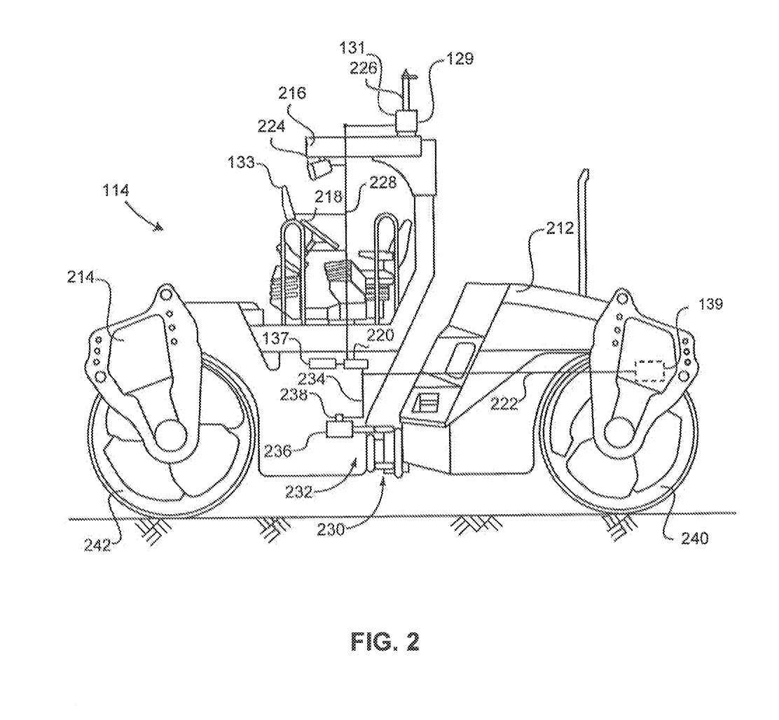

FIG. 2 illustrates compacting machine 114 in greater detail. Compacting machine 114 may include a first frame unit 212, a second frame unit 214, and an operator cabin 216 having therein a navigation device 218, such as a steering wheel. As shown in FIG. 2, processing device 137 may be coupled with a data interface 220 that is connected to sensor 139 via a communication line 222. Data interface 220 may be also connected with receiver 129, display device 133, an image capturing device 224, a locating device 226, and navigation device 218 via at least communication line 228.

In one embodiment, compacting machine 114 may include an articulation joint 230 coupling first and second frame units 212 and 214, and may further include a steering system 232 to steer compacting machine 114 during operation. To this end, navigation device 218, or an autonomous driving module associated with processing device 137, may communicate steering control signals via yet another communication line 234 to steering system 232. In one specific embodiment, steering system 232 may include one or more steering actuators 236, such as hydraulic cylinders, having one or more control valves 238 coupled therewith. Steering control signals may be used to adjust a position, speed, direction, etc., of actuators 236 to control travel of compacting machine 114. In some embodiments, compacting machine 114 may also be equipped with an electronically and/or operator controlled throttle (not shown), and possibly other control features such as a vibratory apparatus (not shown) associated with one or more compacting drums 240 and 242. Additionally or alternatively, compacting machine 114 may include apparatus for sensing a smoothness and/or stiffness of paving material over which compacting machine 114 is travelling. Transmitter 131 may be equipped to transmit data that includes smoothness and/or stiffness information for use in system control and/or contract validation, etc.

Compacting machine 114 is shown as having dual drums 240 and 242. However, other types of compacting machines may be suitable for use in the context of the present disclosure. In non-articulated versions of compacting machine 114, for instance, a different type of steering system may be used. Further, belted compacting machines or compacting machines having a single rotating compacting unit, or more than two compacting units, are contemplated herein. Rather than a self-propelled compacting machine as shown, compacting machine 114 might be a tow-behind or pushed unit configured to couple with a tractor (not shown). An autonomous compacting machine is also contemplated herein.

Sensor 139 may be any type of sensor, or sensor group, which is configured to sense some parameter value that is indicative of, either directly or indirectly, a compaction response of the paving material in the work area. Sensor 139 may be separate from or integral with compacting machine 114. Positioning of sensor 139 on compacting machine 114 can provide real-time information that may be used for determining the rolling pattern. For example, sensor 139 may sense a relative rolling resistance of the paving material as compacting machine 114 moves across the work area. In response, sensor 139 may output the sensed values to processing device 137, via communication line 222. Descriptions herein of “paving material” should not be construed in a limiting sense. Soil, sand, gravel, concrete, asphalt, landfill trash, mixtures including any of the foregoing, etc., are all contemplated as paving materials suitable for compaction via the methods and apparatuses described here

In one embodiment, compacting machine 114 may use a single image capturing device to acquire real-time image data for input to processing device 137. Alternatively, compacting machine 114 may use a plurality of image capture devices to acquire the real-time image data. The term image capture device refers to any type of device suitable of detecting and converting optical signals in the near-infrared, infrared, visible, and ultraviolet spectrums into electrical signals. The term image data includes any form of data retrieved from optical signals, for example, the image data may include video streams and/or images. In one example, image capturing device 224 may be positioned in operator cabin 216. Alternatively, a first image capturing device 224 may be mounted to first frame unit 212 and a second image capturing device 224 may be mounted to second frame unit 214.

In some embodiments, locating device 226 may determine the location of compacting machine 114 and/or the relative position of compacting machine 114 within the work area. The determination of the location and/or the relative position of compacting machine 114, together with the determination of a paving material compaction response, may enable processing device 137 to determine the rolling pattern for compacting machine 114. The rolling pattern may be provided to guide compacting machine 114. For example, the rolling pattern may identify regions wherein supplemental compaction of the paving material is desired. In addition, the rolling pattern may identify regions where supplemental compaction effort will be futile, such that wasted effort is avoided.

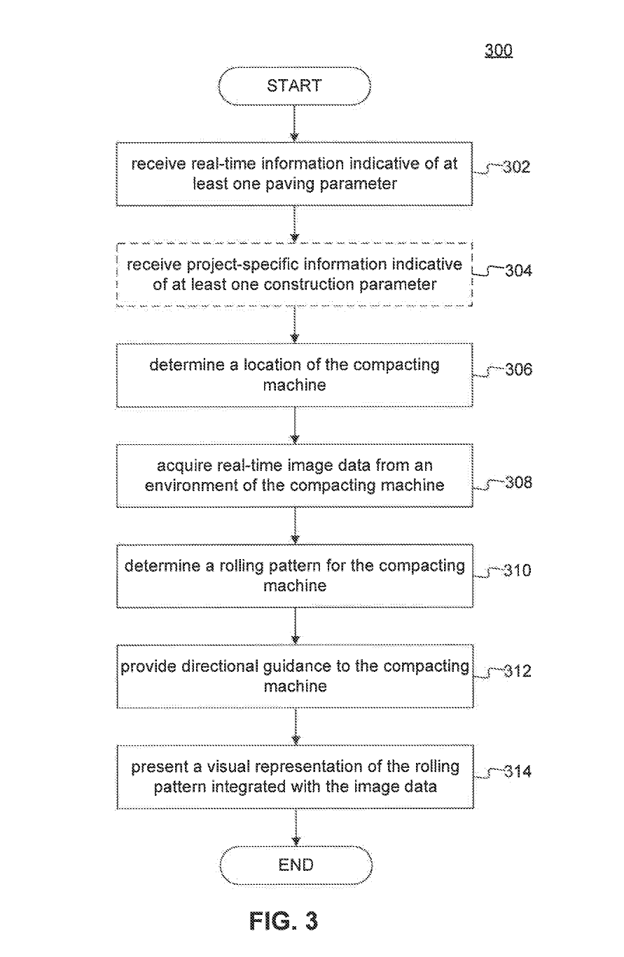

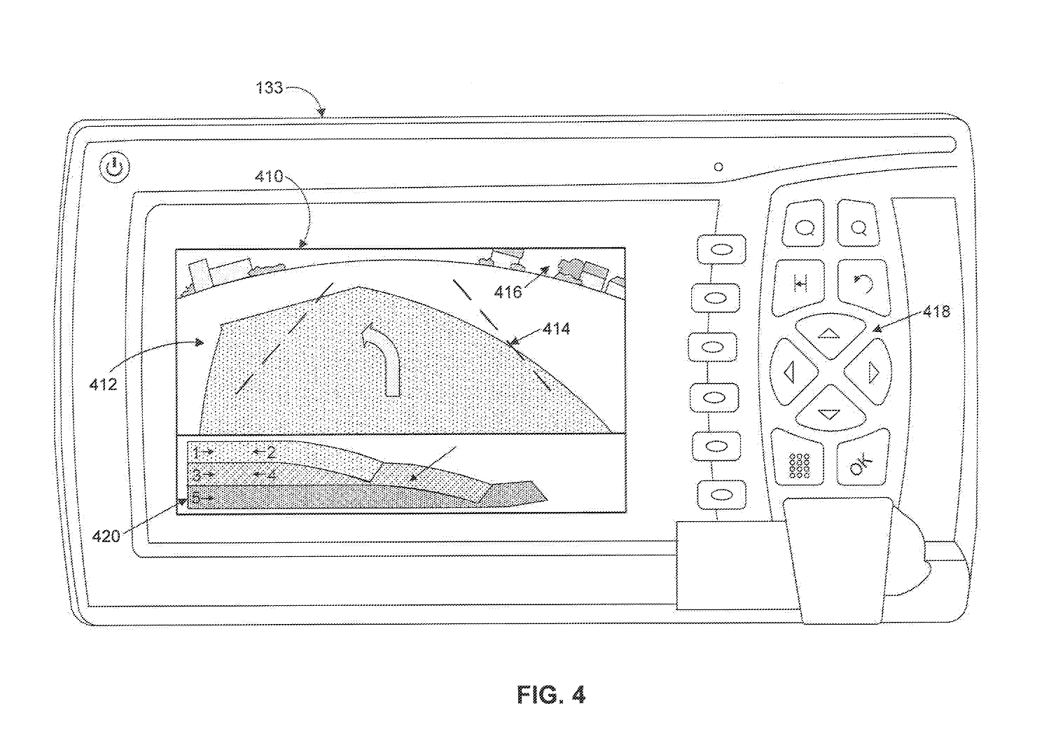

FIG. 3 is a flow chart illustrating an exemplary process 300. Exemplary process 300 describes how processing device 137 can guide compacting machine 114 using a rolling pattern determined based on information retrieved from one or more sources. FIG. 4 is an isometric illustration of display device 133 showing a graphical user interface. The graphical user interface illustrates how a visual representation of the rolling pattern may be integrated with captured image data.

### INDUSTRIAL APPLICABILITY

The disclosed guidance system may be applicable to any compacting machine. The above capabilities of control system 135 may be embodied in exemplary process 300 for guiding a compacting machine. Exemplary process 300 is to be construed as non-exclusive. Specifically, the steps of exemplary process 300 may be modified in any manner, including by reordering steps and/or inserting or deleting steps. It is intended, therefore, that exemplary process 300 be considered as illustrative only.

At step 302, system 135 may receive real-time information indicative of at least one paving parameter. In some embodiments, system 135 may include a data interface (e.g., data interface 220) configured to receive the real-time information. The term “data interface” includes any device configured to receive digital data from one or more sources. The disclosed embodiments are not limited to any particular data interface configurations or protocol. In some embodiments, system 135 may receive real-time information from the sensors associated with compacting machine 114 (e.g., from sensor 139), and sensors associated with paving machine 112 (e.g., from sensor 138). As mentioned above the real-time information may be indicative of at least one paving parameter. Consistent with embodiments of this disclosure, the at least one paving parameter may be part of a group of parameters that includes temperature-related parameters. This may include, for example, the temperature of the paving material as measured at paving machine 112, the temperature of the paving material as measured at compacting machine 114, the ground temperature, the air temperature, the predicted cooling rate, ambient temperature, etc. The at least one paving parameter may also include paver-related parameters, for example, the velocity of paving machine 112, the paving rate, the paving material depth, etc. In addition, the at least one paving parameter may also include compactor-related parameters, for example, the velocity of compacting machine 114, the frequency of drums 240, 242, the amplitude of drums 240, 242, etc.

At step 304, system 135 may receive project-specific information indicative of at least one construction parameter. System 135 may receive the project-specific information from a data interface (e.g., data interface 220). In some embodiments, system 135 may communicate with a paving machine co-located at a common worksite (e.g., paving machine 112), with a work site management center, and with a remote control station (e.g., control station 140). The data interface may receive the project-specific information from one or more input devices associated with at least one of compacting machine 114, paving machine 112, and remote control station 140. As mentioned above, the project-specific information may be indicative of at least one construction parameter. In some embodiments, the at least one construction parameter may be part of a group of parameters that includes mixture-related parameters, for example different characteristics of the paving material: composition, chemical properties, physical properties, amount, graduation, size, shape, etc. The at least one construction parameter may also include machine-related parameters, for example the types of the machines being used, the models of the machines being used, the machines' status, etc. In addition, the at least one construction parameter may include job-related parameters, for example, a required width of lane to compact, a required length of lane to compact, a type of paving project, etc.

At step 306, system 135 may determine a location of compacting machine 114. According to some embodiments consistent with the present disclosure, system 135 may include a locating device (e.g., locating device 226) for determining the location of compacting machine 114. The term locating device refers to any geographical locating device, regardless of whether it receives a signal from a separate receiver (e.g., receiver 129), or has an internal receiver configured to receive signals from a wireless network, e.g., a satellite network or a cellular network. In some embodiments, the locating device may be further configured to determine the relative position of compacting machine 114 to other machines within a work area.

At step 308, system 135 may acquire real-time image data from the environment of compacting machine 114. In some embodiments, system 135 may include at least one image capture device (e.g., image capture device 224) configured to acquire real-time image data from an environment of compacting machine 114. Processing device 137 may be configured to retrieve information from the image data from the environment of compacting machine 114, and use the information retrieved from the image data in determining a rolling pattern. In some embodiments, the information retrieved from processing the image data may include identifying objects in the path of compacting machine 114, for example, vehicles, pedestrians, road signs, and more.

At step 310, system 135 may determine a rolling pattern for compacting machine 114. System 135 may determine the rolling pattern using information from one or more sources. Specifically, processing device 137 may use a combination of any of the information received and/or determined in steps 302-308. In a first example, processing device 137 may use the real-time information to determine the rolling pattern. In a second example, processing device 137 may use the real-time information and the project-specific information to determine the rolling pattern. In a third example, processing device 137 may use the real-time information, the project-specific information, and the location of compacting machine 114 to determine the rolling pattern. In a fourth example, processing device 137 may use the real-time information and information retrieved from processing the image data to determine the rolling pattern. In addition to the information received and/or determined in steps 302-308, supplemental information from various sources may be used (e.g., from a weather forecast).

In some embodiments, determining the rolling pattern includes determining at least one of a vibrational amplitude of compacting machine 114, a vibrational frequency of compacting machine 114, and a required number of passes that compacting machine 114 should make (e.g., five passes or seven passes). Consistent with disclosed embodiments, the rolling pattern may identify a first mixture area having compacting priority over a second mixture area. The first mixture area and the second mixture area may be adjacent to each other and may be undistinguishable to an ordinary observer. However, identifying the first and second mixture areas enables processing device 137 to guide compacting machine 114 to the first mixture area before the second mixture area. In some cases, the rolling pattern may depend on the location of compacting machine 114 relative to the first mixture area to be compacted. For example, assuming the first mixture area to be compacted is on the right of compacting machine 114, after compacting machine 114 has turned to the right, the first mixture area to be compacted would be in front of compacting machine 114 and the rolling pattern would change accordingly.

At step 312, system 135 may provide directional guidance to compacting machine 114. In one embodiment, processing device 137 is configured to provide directional guidance based on the location of compacting machine 114 and the rolling pattern. In case compacting machine 114 is an autonomous machine, the directional guidance may be provided to a navigation module. The navigation module may then guide compacting machine 114 to compact an area without operator intervention. Alternatively, the directional guidance may be provided to the operator of compacting machine 114 via a display (e.g., display device 133), a speaker, a tactile device, and/or any other devices for providing output information to a user. In some embodiments, the directional guidance may include guidance to the first mixture area identified as having a compacting priority over the second mixture area. In addition, processing device 137 may further provide guidance regarding at least one of: a velocity of compacting machine 114, the vibration amplitude of drums 240 and 242, and the frequency of drums 240 and 242. Thus, the operator of compacting machine 114 would know where to compact and what compacting parameters to apply.

At step 314, system 135 may present a visual representation of the rolling pattern integrated with the image data. In some embodiments, display device 133 may present the real-time image data acquired at step 308 to the operator, and processing device 137 may show a visual representation of the rolling pattern integrated with the image data on display device 133. Specifically, the visual representation may provide guidance to a first mixture area and to the second mixture area. In one embodiment, presenting the visual representation of the rolling pattern integrated with the image data includes overlapping the visual representation on top of the image data.

Consistent with disclosed embodiments, non-transitory computer-readable storage media that may store one or more software products is provided. When a software product is executed by processing device 137 it may cause compacting machine 114 to perform any or all steps of exemplary process 300.

An illustration of how the visual representation of the rolling pattern may be integrated with the image data is illustrated in FIG. 4. Display device 133 may take the form of a portable device including a screen 410 configured to display a graphical user interface 412. Graphical user interface 412 may display a visual representation 414 of the rolling pattern integrated with the image data 416. Graphical user interface 412 may further display two dashed lines representing the center of image data 416, and a left arrow indicating that compacting machine 114 needs to turn left. Consistent with exemplary embodiment of the present disclosure, visual representation 414 may include a dotted area representing the area to compact first, e.g., the first mixture area. Also, image data 416 may be a live video stream capturing the moving direction of compacting machine 114. Display device 133 may also include one or more keys 418 to input data, for example, to input project-specific information. Alternatively, screen 410 maybe a touchscreen enabling the operator to input data. In some embodiments, the visual representation changes according to the movement of compacting machine 114, such that when the operator of compacting machine 114 looks at display device 133, he/she would immediately understand which way to steer compacting machine 114.

In some embodiments, graphical user interface 412 may include information regarding the velocity of compacting machine 114. In other embodiments, graphical user interface 412 may include information regarding the vibration amplitude and/or the frequency of drums 240 and 242. The information may be presented after the operator presses one of keys 418. For example, graphical user interface 412 may display one or more bar charts (not shown) illustrating the current velocity of compacting machine 114 compared to the recommend velocity, the current vibration amplitude of drums 240 and 242 compared to the recommend vibration amplitude, and/or the current frequency of drums 240 and 242 compared to the recommend frequency. Graphical user interface 412 may further display a representation of the compacting process progress 420. The representation of the compacting process progress indicates the current pass number out of the total passes determined for the job. In one embodiment, the dotted area representing the first mixture area in visual representation 414 of the rolling pattern may have the same color (or dots density) as the current pass number in representation of the compacting process progress 420.

It will be apparent to those skilled in the art that various modifications and variations can be made to system 135. Other embodiments will be apparent to those skilled in the art from consideration of the specification and practice of the disclosed system. It is intended that the specification and examples be considered as exemplary only, with a true scope being indicated by the following claims and their equivalents.

What is claimed is:

1. A guidance system for a compacting machine, comprising:
a data interface configured to receive real-time information indicative of a paving parameter and project-specific information indicative of a construction parameter;
a locating device configured to determine a location of the compacting machine; and
a processing device in communication with the data interface and the locating device, wherein the processing device is configured to:
use the real-time information and the project-specific information to determine a rolling pattern for the compacting machine; and
based on the location of the compacting machine and the rolling pattern, provide directional guidance to the compacting machine.

2. The guidance system of claim 1, wherein:
the rolling pattern identifies a first mixture area having compacting priority over a second mixture area; and
the processing device provides the directional guidance to the first mixture area.

3. The guidance system of claim 1, wherein the rolling pattern depends on the location of the compacting machine relative to a first mixture area.

4. The guidance system of claim 1, further including one or more sensors associated with at least one of the compacting machine and an associated paving machine, wherein the data interface receives the real-time information from the one or more sensors.

5. The guidance system of claim 4, wherein the paving parameter includes at least one of a temperature-related parameter, a paver-related parameter, and a compactor-related parameter.

6. The guidance system of claim 1, wherein:
the processing device is in further communication with a paving machine co-located at a common worksite with the compacting machine, with a management center, and a remote control station; and
the data interface is configured to receive the project-specific information from one or more input devices associated with at least one of the compacting machine, the paving machine, the management center, and the remote control station.

7. The guidance system of claim 6, wherein the construction parameter includes at least one of a mixture-related parameter, a machine-related parameter, and a job-related parameter.

8. The guidance system of claim 1, wherein the rolling pattern includes at least one of a vibrational amplitude of the compacting machine, a vibrational frequency of the compacting machine, and a required number of passes that the compacting machine should make.

9. The guidance system of claim 1, further including a display device located inside the compacting machine, wherein the processing device is configured to present the directional guidance to an operator of the compacting machine on the display device.

10. The guidance system of claim 9, further including at least one image capturing device configured to acquire real-time image data from an environment of the compacting machine, wherein:
the display device is further configured to present the real-time image data to the operator, and
the processing device is configured to show a visual representation of the rolling pattern integrated with the image data on the display device.

11. The guidance system of claim 1, wherein the processing device is further configured to provide guidance regarding a velocity of the compacting machine and a frequency of a drum associated with the compacting machine.

12. A guidance system for a compacting machine, comprising:
a data interface configured to receive real-time information indicative of a paving parameter;
an image capture device configured to acquire real-time image data from an environment of the compacting machine;
a display device located inside the compacting machine; and
a processing device configured to:
use the real-time information to determine a rolling pattern for the compacting machine; and
present a visual representation of the rolling pattern integrated with the image data on the display device.

13. The guidance system of claim 12, wherein:
the rolling pattern identifies a first mixture area having rolling priority over a second mixture area; and
the visual representation provides guidance to the first mixture area.

14. The guidance system of claim 12, wherein the processing device is further configured to overlap the visual representation on top of the image data.

15. The guidance system of claim 12, wherein the processing device is further configured to present information regarding a recommended velocity for the compacting machine and a recommended frequency for a drum associated with the compacting machine.

16. The guidance system of claim 12, wherein the visual representation changes according to movement of the compacting machine.

17. The guidance system of claim 12, wherein the processing device is further configured to retrieve information from image data, and to use information to determine the rolling pattern.

18. The guidance system of claim 12, wherein the processing device is further configured to present a representation of compacting process progress on the display device.

19. The guidance system of claim 12, wherein the processing device is further configured to determine the rolling pattern based on project-specific information indicative of at least one of a mixture-related parameter, a machine-related parameter, and a job-related parameter.

20. A software product stored on a non-transitory computer readable medium and comprising data and computer implementable instructions, which when executed by a processing device of a compacting machine cause the compacting machine to perform operations comprising:
receiving real-time information indicative of a paving parameter;
acquiring real-time image data from an environment of the compacting machine;
using the real-time information to determine a rolling pattern for the compacting machine; and
displaying a visual representation of the rolling pattern integrated with the image data.

21. A compacting machine, comprising:
a data interface configured to receive real-time information indicative of a paving parameter and project-specific information indicative of a construction parameter;
a locating device configured to determine a location of the compacting machine; and
a processing device in communication with the data interface and the locating device, wherein the processing device is configured to:
use the real-time information and the project-specific information to determine a rolling pattern for the compacting machine; and
based on the location of the compacting machine and the rolling pattern, provide directional guidance to an operator of the compacting machine.

22. The compacting machine of claim 21, wherein:
the rolling pattern identifies a first mixture area having compacting priority over a second mixture area; and
the processing device provides the directional guidance to the first mixture area.

23. The compacting machine of claim 21, wherein the rolling pattern depends on the location of the compacting machine relative to a first mixture area.

24. The compacting machine of claim 21, further including one or more sensors associated with at least one of the compacting machine and an associated paving machine, wherein the data interface receives the real-time information from the one or more sensors.

25. The compacting machine of claim 24, wherein the paving parameter includes at least one of a temperature-related parameter, a paver-related parameter, and a compactor-related parameter.

26. The compacting machine of claim 21, wherein:
the processing device is in further communication with a paving machine co-located at a common worksite with the compacting machine, with a management center, and a remote control station; and
the data interface is configured to receive the project-specific information from one or more input devices associated with at least one of the compacting machine, the paving machine, the management center, and the remote control station.

27. The compacting machine of claim 26, wherein the construction parameter includes at least one of a mixture-related parameter, a machine-related parameter, and a job-related parameter.

28. The compacting machine of claim 21, wherein the rolling pattern includes at least one of a vibrational amplitude of the compacting machine, a vibrational frequency of the compacting machine, and a required number of passes that the compacting machine should make.

29. The compacting machine of claim 21, further including a display device located inside the compacting machine, wherein the processing device is configured to present the directional guidance to the operator of the compacting machine on the display device.

30. The compacting machine of claim 29, further including at least one image capturing device configured to acquire real-time image data from an environment of the compacting machine, wherein:
the display device is further configured to present the real-time image data to the operator, and
the processing device is configured to show a visual representation of the rolling pattern integrated with the image data on the display device.

31. The compacting machine of claim 21, wherein the processing device is further configured to provide guidance regarding a velocity of the compacting machine and a frequency of a drum associated with the compacting machine.
